(19) United States
(12) Patent Application Publication
(10) Pub. No.: US 2013/0029534 A1
(43) Pub. Date: Jan. 31, 2013

(54) CONNECTOR WITH WIRELESS CONNECTIVITY

(71) Applicants: Robert Yockey, Fort Collins, CO (US); Jon R. Dory, Fort Collins, CO (US); Raymond Cundiff, Johnstown, CO (US)

(72) Inventors: Robert Yockey, Fort Collins, CO (US); Jon R. Dory, Fort Collins, CO (US); Raymond Cundiff, Johnstown, CO (US)

(73) Assignee: HEWLETT-PACKARD DEVELOPMENT COMPANY, L.P., Fort Collins, CO (US)

(21) Appl. No.: 13/639,507

(22) PCT Filed: Apr. 13, 2010
(86) PCT No.: PCT/US2010/030803

§ 371 Date: Oct. 4, 2012

(51) Int. Cl. H01R 24/28

(52) U.S. Cl. 439/660

(57) ABSTRACT

The apparatus discloses a first connector; a wireless interface, coupled to pass wireless signals through the first connector; and a second connector, coupled to pass hardwire signals through the first connector; wherein the apparatus is powered through, either the first connecter or the second connector.

### BACKGROUND OF THE INVENTION

### Field Of The Invention

The present invention relates generally to apparatus and systems for connecting devices, and more particularly toward a connector with wireless connectivity.

### BRIEF DESCRIPTION OF THE DRAWINGS

Some examples of the invention are described in the following figures;

FIG. 1 is an example of a system using a first connector with wireless connectivity;

FIG. 2 is an example of a system using a second connector with wireless connectivity;

FIG. 3 is an example of a system using a third connector with wireless connectivity;

FIG. 4 is a first example view of the second connector having wireless connectivity; and

FIG. 5 is a second example view of the second connector having wireless connectivity.

### DETAILED DESCRIPTION

Hardware devices, including computers, notebooks, netbooks, laptops, microcontroller-based devices, etc., have space for and provide only a very limited number of connector ports, typically intended for various peripheral devices, such as a keypad, mouse, security devices, portable hard-drive, flash-drive, power supply, monitor, printer, etc. These connector ports come in many forms including: USB, PS/1, PS/2, FireWire, phone plug, power plug, D-Sub, various serial and parallel ports, phone jacks, CAT5, and so on.

Wireless connectivity between peripheral devices and hardware devices is often preferred as well. For a wireless device to interface with such hardware, the hardware device must either have a wireless interface built-in, or must consume one of its connector ports with a wireless interface device, to enable such wireless connectivity. The latter solution is often necessitated when the hardware device cost has been kept low by the deletion of a built-in wireless interface.

A miniature wireless dongle can be connected to one of the ports on the hardware device so as to provide the desired wireless connectivity to the peripheral devices. However, the dongle necessarily consumes at least one of the limited number of connection ports on the hardware device. This is one less connection port that can be used for other purposes, and may be an important concern on a hardware device which only has one or two such connection ports. Such a paucity of connection ports is particularly pronounced on netbooks, which host a very limited number of connection ports.

Several wireless dangles interface with hardware devices using USB connection ports. To work around the USB port consumed by the wireless dongle, a USB-Hub device could be fitted to the hardware device. However, particularly tor mobile applications, the need to constantly carry around and connect and disconnect a large and bulky USB-Hub device is an less than optimal solution to this concern.

The present invention addresses and remedies many, if not all, of the problems discussed above.

The present invention provides a form factor which not only provides for wireless connectivity between peripheral devices and hardware devices; but also, effectively duplicates the connection port, thus enabling other peripheral devices to connect to the hardware devices in parallel with the wireless capability. In one embodiment, the invention adds the wireless functionality to the connector of an otherwise single-ended peripheral device. In another embodiment, the invention provides the wireless functionality and also replicates/duplicates the connector port so that other peripheral devices can also be connected.

Some examples of the invention include a single-ended peripheral device (such as a mouse, keypad, printer, flash-drive, hard-drive, etc.) having a USB connector that not only connects the peripheral device to the host hardware device, but which also provides for wireless connectivity.

Other examples of the invention include a miniature dongle which not only provides for wireless connectivity, but also replicates/duplicates the connector port the dongle is connected to (e.g. a USB-dongle which itself includes a USB-connection port). This effectively preserves the connection port which would otherwise be consumed by a wireless dongle. One of the advantages of this other embodiment is a small form factor which enables users to plug the invention in, leave it in, and forget about it. In this way, the invention need not be repeatedly attached and removed.

Details of the present invention are now discussed.

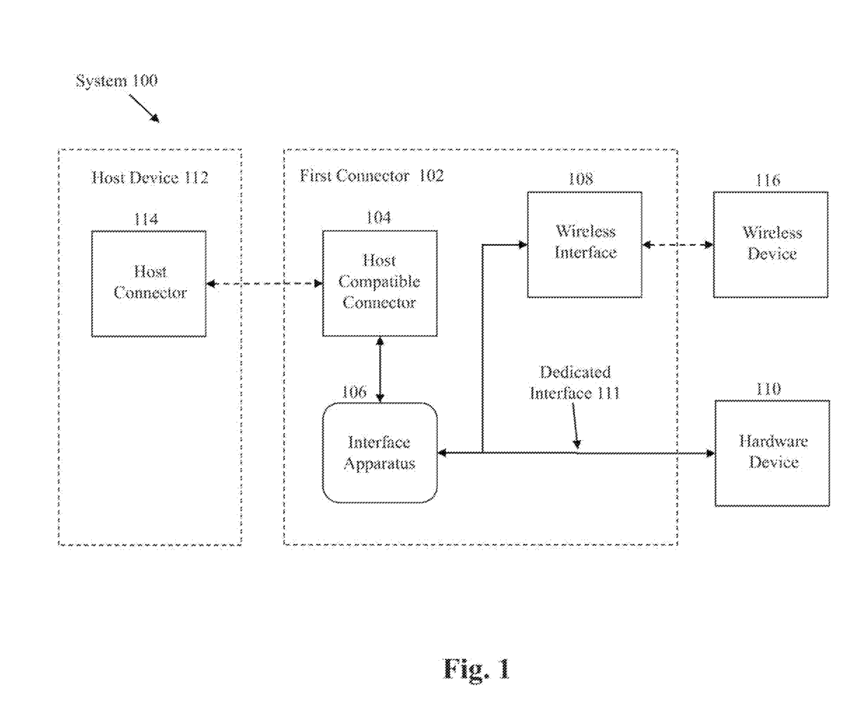

FIG. 1 is an example of a system 100 using a first connector 102 with wireless connectivity. The first connector 102 is integrated with a single-ended hardware device 110, and includes: a host compatible connector 104, an interface apparatus 106, a wireless interface 108, and a dedicated interface 111. The system 100 also includes a host device 112, a host connector 114, and a wireless device 116.

Within the first connector 102, the host compatible connector 104 detachable couples to the host connector 114 on the host device 112. The host device 112 could be any hardware device, including: a computer, notebook, netbook, laptops, microcontroller-based device, mobile phone, monitor, and so on. In one embodiment, the host compatible connector 104 and the host connector 114 are USB connectors, however, in other embodiments, these connectors 104 and 114 could be of any type, such as: PS/1, PS/2, FireWire, phone ping, power ping, D-Sub, various serial and parallel ports, phone jacks, CAT5, and so on.

The interface apparatus 106 transmits and receives signals to and from the host compatible connector 104 as well as to both the wifeless interface 108 and the single-ended hardware device 110. Some examples of the single-ended hardware device 110 include a computer mouse and a computer keypad; however, the single-ended hardware device 110 could in alternate embodiments be various devices such as those provided as possible examples of the host device 112, above. The interface apparatus 106 circuitry, in one embodiment, is powered by the host device 112. For example, if the host compatible connector 104 is a USB connector, the host device 112 would be able to provide power to the interface apparatus 106. However, in other embodiments, the interface apparatus 106 could be powered by the single-ended hardware device 110.

In one embodiment, the interface apparatus 106 functions as a HUB device, enabling the host device 112 to communicate with both the wireless interface 108 and the single-ended hardware device 110. In other embodiments, the interface apparatus 106 may enable the host device 112 to communicate with three or more other hardware or wireless devices (not shown).

The dedicated interface 111 couples the single-ended hardware device 110 to the interface apparatus 106, and in one example is a type of cable having one or more wires which couples the interface apparatus 106 to the single-ended hardware device 110. The dedicated interface 111 passes hardwire signals between the single-ended hardware device 110 and the interface apparatus 106. Hardwire signals are herein defined to include signals transmitted over various conductive media, such as wire, optical fiber, and so on.

The wireless interface 108 passes wireless signals to and from the wireless device 116. Passing is herein defined to include the transmission, and/or reception of wireless signals. The wireless interface 108 is compliant with one or more wireless communication protocols, and can in some embodiments, communicate with more than one wireless device 116. Some examples of the wireless device 116 include a computer mouse and a computer keypad; however, the wireless device 116 could in alternate embodiments be various devices such as those provided as possible examples of the host device 112, above.

The wireless interface 108 circuitry, in one embodiment, is also powered by the host device 112, and/or the single-ended hardware device 110. For example, if the host compatible connector 104 is a USB connector, the host device 112 would be able to provide power to the wireless interface 108.

Integrated together, the first connector 102 in the system 100 adds a wireless capability to a connector which otherwise couples the single-ended hardware device 110 to the host device 112. All of the electronics supporting first connector 102, including the interface apparatus 106 and the wireless interface 108, are housed within a compact volume surrounding the host compatible connector 104.

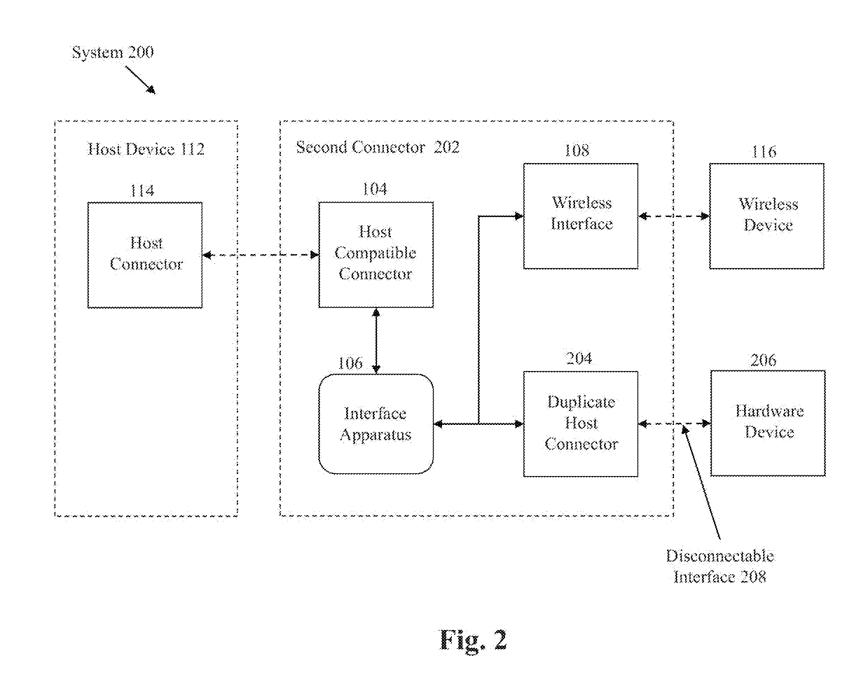

FIG. 2 is an example of a system 200 using a second connector 202 with wireless connectivity. The second connector 202 includes the host compatible connector 104, the interface apparatus 106, and the wireless interface 108 discussed above with reference to FIG. 1. The second connector 202 further includes a duplicate host connector 204. The system 200 also includes the host device 112, the host connector 114, and the wireless device 116 discussed above with reference to FIG. 1. The system 200 further includes a hardware device 206, and a disconnectable interface 208.

The interface apparatus 106 transmits and receives signals between the host device 112 and the duplicate host connector 204. The hardware device 206 is coupled to receive the signals from the interface apparatus 106 via the duplicate host connector 204 and the disconnectable interface 208. Some examples of the hardware device 206 include a computer mouse and a computer keypad; however, the hardware device 206 could in alternate embodiments be various devices such as those provided as possible examples of the host device 112, above. The disconnectable interface 208 passes hardwire signals between the hardware device 206 and the interface apparatus 106. One example of the disconnectable interface 208 is a USB cable from a mouse or keypad. The disconnectable interface 208 could also, in one embodiment be a USB connector on a removable memory device (e.g. flash-memory thumb drive).

In one embodiment, the duplicate host connector 204 duplicates (e.g., replicates) the host connector 114. In such an embodiment, since the duplicate host connector 204 and the host connector 114 are functionally identical, addition of the wireless interface 108, and the related ability to communicate with the wireless device 116, does not effectively consume the host connector 114 on the host device 112. In this way, the second connector 202 passes-through signals from the host device 112, and thus the duplicate host connector 204 is ready to accept additional hardware devices. In other embodiments, the duplicate host connector 204 can be of a different connection-port type than the host connector 114.

The host compatible connector 104 and the duplicate host connector 204 are in one embodiment positioned back-to-back with respect to each other, in as close proximity as is possible so as to keep the overall length of the second connector 202 as short as possible. In such an embodiment, the second connector 202 take the form-factor of a “dongle” device.

The required electrical circuitry and connections for the second connector 202 are maintained in a volume surrounding the host compatible connector 104 and the duplicate host connector 204. The second connector 202 circuitry, in one embodiment, is powered by the host device 112. For example, if the host compatible connector 104 is a USB connector, the host device 112 would be able to provide power to the second connector 202. However, in other embodiments, the second connector 202 could be powered by the hardware device 206.

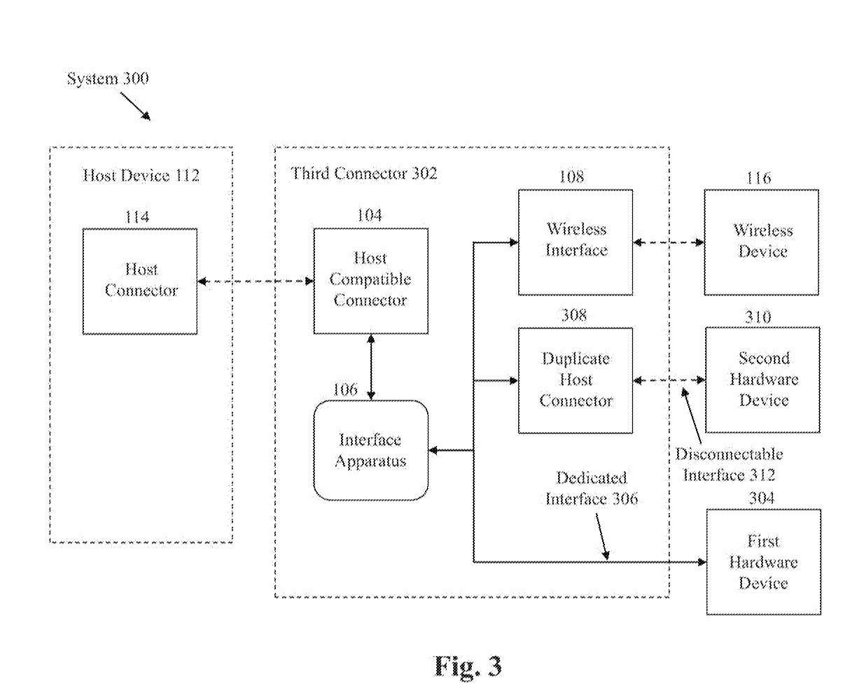

FIG. 3 is an example of a system 300 using a third connector 302 with wireless connectivity. The third connector 302 is integrated with a single-ended first hardware device 304, and includes: the host compatible connector 104, the interface apparatus 106, and the wireless interface 108, discussed above with reference to FIG. 1. The third connector 302 further includes: a dedicated interface 306, and a duplicate host connector 308. The system 300 also includes the host device 112, the host connector 114, and the wireless device 116, discussed above with reference to FIG. 1. The system 300 further includes a second hardware device 310, and a disconnectable interface 312.

The interface apparatus 106 transmits and receives signals between the host device 112 and the duplicate host connector 308. The first hardware device 304 is coupled to receive the signals from the interface apparatus 106 via the dedicated interface 300. The second hardware device 310 is coupled to receive the signals from the interface apparatus 106 via the duplicate host connector 308 and the disconnectable interface 312. Some examples of the first and second hardware devices 304 and 310 include a computer mouse and a computer keypad; however, these devices 304 and 310 could in alternate embodiments be various devices such as those provided as possible examples of the host device 112, above.

In one embodiment, the duplicate host connector 308 duplicates the host connector 114, as discussed with respect to FIG. 2.

The required electrical circuitry and connections for the third connector 302 are maintained in a volume surrounding the host compatible connector 104 and the duplicate host connector 308. The third connector 302 circuitry, in one embodiment, is powered by the host device 112. For example, if the host compatible connector 104 is a USB connector, the host device 112 would be able to provide power to the third connector 302.

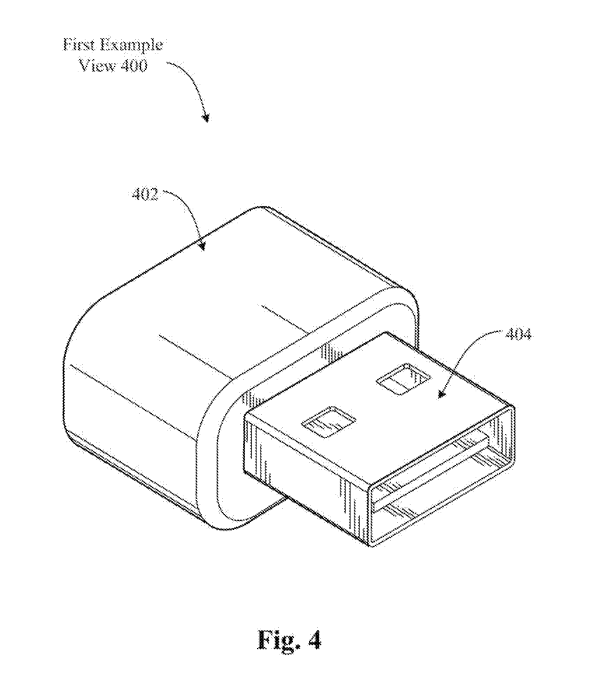

FIG. 4 is a first example view 400 of the second connector 202 having wireless connectivity. The view 400 shows a housing 402, and a host compatible connector 404. The host compatible connector 404 is a USB, Type A, male connector. The housing 402 encloses the required electrical circuitry and connections for the second connector 202.

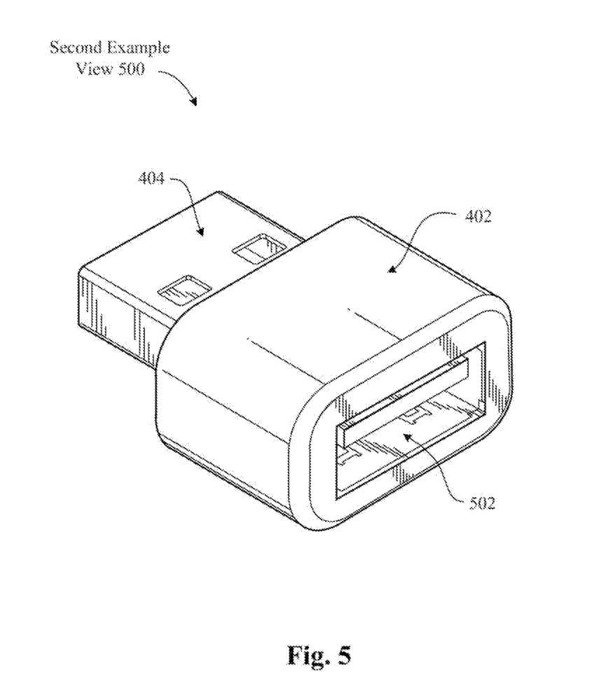

FIG. 5 is a second example view 500 of the second connector 202 having wireless connectivity. The view 500 shows the housing 402, the host compatible connector 404, and a duplicate host connector 502. The duplicate host connector 502 is a USB, Type A, female connector. As can be seen from FIGS. 4 and 5, the host compatible connector 404 and the duplicate host connector 502 are physically disposed back-to-back with respect to each other, and are also generally along a same axis with respect to each other. In this way, the second connector 202 does not tend to block or interfere with neighboring connection ports on the host device 112.

Several additional embodiments and/or implementations of the present invention are possible. In one additional embodiment, the duplicate host connectors 204 and 308 can be attached to their respective connectors 202 and 302 using an additional “small cable”. In an additional embodiment, several of the connectors 102, 202, and 302 can be “stacked” end-to-end if desired, perhaps providing multiple wireless channels. In some embodiments, the connectors 102, 202, and 302 may include a flash RAM memory, perhaps to provide a cache-feature during high data volume transfers.

In the foregoing description, numerous details are set forth to provide an understanding of the present invention. However, it will be understood by those skilled in the art that the present invention may be practiced without these details. An article or article of manufacture can refer to any manufactured single component or multiple components. Also, while the invention has been disclosed with respect to a limited number of embodiments, those skilled in the art will appreciate numerous modifications and variations thereof. It is intended that the following claims cover such modifications and variations as fall within the true spirit and scope of the invention.

What is claimed is:

1. An apparatus connectable to a host device through a host connector, comprising:
a first connector, capable of being coupled to the host connector;
a wireless interface, coupled to pass wireless signals to the host device through the first connector, when the first connector is coupled to the host connector; and
a second connector, coupled to pass hardwire signals to the host device through the first connector, when the first connector is coupled to the host connector; and
wherein the apparatus is powered through at least one from a group including: the first connector and the second connector.

2. The apparatus of claim 1:
wherein the second connector is a duplicate of the first connector.

3. The apparatus of claim 2:
wherein the second connector is a USB-female connector and the first connector is a USB-male connector.

4. The apparatus of claim 1:
wherein the first connector and the second connector are physically disposed back-to-back with respect to each other.

5. The apparatus of claim 1:
wherein the first connector and the second connector are physically disposed generally along a same axis with respect to each other.

6. The apparatus of claim 1:
wherein the first connector is coupled to the host connector by at least one from a group including: a USB port, a PS/1 port, a PS/2 port, a Fire Wire port, a power plug port, a D-Sub port, a serial port, a parallel port, a phone jack port, and a CAT5 port.

7. The apparatus of claim 1, further comprising:
an interface apparatus coupled to route signals between the first connector, the second connector, and the wireless interface.

8. The apparatus of claim 7:
wherein the interface apparatus functions as a HUB device.

9. The apparatus of claim 1:
wherein the wireless interface wirelessly communicates with at least one from a group including a: mouse, keypad, printer, flash-drive, hard-drive, computer, notebook, netbook, laptop, microcontroller-based device, phone, a keypad, mouse, a security device, power supply, monitor, and printer.

10. The apparatus of claim 1, further comprising:
a memory device for caching data from the wireless interface and the second connector.

11. An apparatus connectable to a host device through a host connector, comprising:
a first connector, capable of being coupled to the host connector;
a wireless interface, coupled to pass wireless signals to the host device through the first connector, when the first connector is coupled to the host connector; and
a single-ended hardware device, coupled to pass hardwire signals through a dedicated interface to the host device through the first connector, when the first connector is coupled to the host connector; and
wherein the apparatus is powered through at least one from a group including: the first connector and the second connector.

12. The apparatus of claim 11:
wherein the single-ended hardware device functions as at least one from a group including a: mouse, keypad, printer, flash-drive, hard-drive, computer, notebook, netbook, laptop, microcontroller-based device, phone, a keypad, mouse, a security device, power supply, monitor, and printer.

13. The apparatus of claim 11, further comprising:
an interface apparatus coupled to route signals between the first connector, the single-ended hardware device, and the wireless interface.

14. The apparatus of claim 13:
wherein the dedicated interface is a cable designed to be permanently coupled at one end to the interface apparatus and at another end to the single-ended hardware device.

15. A dongle apparatus, comprising:
a first connector;
a wireless interface, coupled to pass wireless signals to the first connector; and
a second connector, coupled to pass hardwire signals to the first connector; and
wherein the apparatus is powered through at least one from a group including: the first connector and the second connector.
